(19) United States
(12) Patent Application Publication
(10) Pub. No.: US 2024/0278186 A1
(43) Pub. Date: Aug. 22, 2024

(54) PREPARATION METHOD, PRODUCT AND APPLICATION OF HYDROPHOBICALLY MODIFIED MEMBRANE BASED ON MULTI-EFFECT THERMAL ENERGY CONVERSION

(71) Applicant: SHENZHEN POLYTECHNIC UNIVERSITY, SHENZHEN (CN)

(72) Inventors: HUAN WANG, SHENZHEN (CN); WEIXIANG CHAO, SHENZHEN (CN); LIJUN ZHU, SHENZHEN (CN); CANLIANG HUANG, SHENZHEN (CN); QIANWEN ZHAO, SHENZHEN (CN); CHENGWEI YAN, SHENZHEN (CN)

(21) Appl. No.: 18/422,095

(22) Filed: Jan. 25, 2024

Related U.S. Application Data
(63) Continuation of application No. PCT/CN2022/139114, filed on Dec. 14, 2022.

(30) Foreign Application Priority Data
Dec. 9, 2022 (CN) 202211576379.1

(51) Int. Cl. B01D 69/12; B01D 67/00; B01D 69/02; B01D 69/10; B01D 71/02; C02F 1/04; C02F 1/14; C02F 1/44; C02F 103/06

(52) U.S. Cl. CPC B01D 69/1214; B01D 67/0069; B01D 67/0083; B01D 67/0086; B01D 67/00931; B01D 69/02; B01D 69/107; B01D 71/0212; C02F 1/048; C02F 1/14; C02F 1/44; B01D 2323/04; B01D 2323/081; B01D 2323/10; B01D 2325/02834; C02F 2103/06

(57) ABSTRACT

Disclosed are a preparation method, a product and an application of a hydrophobically modified membrane based on multi-effect thermal energy conversion, the preparation method includes the steps: S1. dispersing carbon nanotubes with surfaces carboxylated in a solvent to form a dispersion; S2. applying the dispersion evenly on a PVDF membrane, and drying to form a ready-to-use membrane; S3. performing thermo-mechanical pressure treatment of the ready-to-use membrane to form a functional membrane with strong robustness; and S4. placing the functional membrane with strong robustness in an alkane solution of PDMS containing a silane coupling agent, and then taking it out for drying.

### TECHNOLOGY FIELD

The present disclosure relates to the technical filed of environmental protection devices, and particularly relates to a preparation method, a product and an application of a hydrophobically modified membrane based on multi-effect thermal energy conversion.

### BACKGROUND

With the acceleration of urbanization process and the improvement of people's living standards in China, municipal solid waste is rapidly growing at an average annual rate of more than 10%. Although an incineration process is applicable to the harmless treatment of the vast majority of municipal solid waste, sanitary landfill remains as the primary treatment method due to the current level of social development, accounting for more than 85% of the harmless treatment processes. However, both a storage stage and a sanitary landfill process of waste incineration will produce highly polluting landfill leachate due to relatively excessive moisture, biochemical degradation, rainfall erosion, and the like. The landfill leachate has complex composition and poses challenges in treatment, and improper treatment of the landfill leachate will seriously pollute surrounding environments. In response to the increasingly stringent discharge standards of landfill leachate, membrane separation technology has become a mainstream leachate treatment process both at home and abroad because of its advantages, such as good treatment effect, simple and stable operation. Nevertheless, membrane concentrate will be produced continuously in the process of membrane treatment. The membrane concentrate takes up about 13-30% (depending on different operating process parameters) of raw water volume of the landfill leachate. Due to higher concentrations of organic matter and salt, and extremely poor biodegradability, the membrane concentrate can cause more serious pollution than that of the original landfill leachate. Therefore, appropriate treatment and disposal technology of the original landfill leachate has become a research hotspot in recent years.

Currently, the membrane concentrate is generally backfilled into a landfill both at home and abroad. Although COD and NH₃—N in the membrane concentrate can be effectively removed through backfilling, the extremely high content of salt in the membrane concentrate makes salty substances incapable of being absorbed, thereby being accumulated in the landfill leachate. An influx of high-salinity landfill leachate will result in significant changes in the quality of influent water and deliver a strong impact, thereby impacting purification efficiency and an effluent recovery rate of, and shortening the service life, of a membrane treatment system. Other treatment processes, such as advanced oxidation process, due to more complicated process paths and treatment technologies, indirectly make the operation and management more difficult, require the addition of large amounts of oxidants and coagulants with strong oxidizing properties, thus producing a large amount of sludge that could cause secondary pollution and increasing post-treatment costs. Evaporation treatment technology is a process that heats the membrane concentrate to evaporate moisture therein, so that a volume of the membrane concentrate is greatly reduced. In the actual evaporation process, only small portions of volatile organic acids, ammonia and volatile hydrocarbons change into condensate with steam, while the rest inorganic substances, heavy metals and most organic substances all remain in the residual concentrate. Existing evaporation treatment technologies are capable of concentrating a volume of the leachate to 2-10% of its original volume, and have the advantages of strong adaptability to changes in water quality and quantity, low residual liquid yield, and the like. Nevertheless, the existing mainstream evaporation treatment technologies still have some technical problems, for example, operating cost of disposal through evaporation of the membrane concentrate can be reduced through low-energy energy recycling technology, which is technically feasible and economically reasonable. However, submerged combustion evaporation process, mechanical compression evaporation process and other processes could result in high-temperature corrosion of evaporation equipment from organic pollutants and salt, and the degree of corrosion tends to intensify as an evaporation temperature rises, which drives up construction investment and subsequent operational maintenance costs. Therefore, it is necessary to develop more reasonable and efficient forms of energy utilization to reduce the energy consumption of traditional evaporation processes, and achieve more sustainable reduction disposal through evaporation of the membrane concentrate.

Solar energy, as one of the most abundant renewable energy sources in nature, has sufficient potential to serve as an energy medium to heat up the membrane concentrate to evaporate and separate an aqueous phase therein, thereby realizing reduction disposal of the membrane concentrate. In recent years, more research has been conducted on solar energy utilization technologies applied in the water treatment industry. Specifically, solar energy evaporation and concentration technology, attributable to its flexible and convenient operation, extremely low cost and other advantages, has received extensive attention. Nevertheless, the direct use of solar energy to heat up water bodies has a lower utilization rate of calorific value and is subjected to fluctuations in natural light intensity, therefore, a water evaporation rate cannot be guaranteed. Moreover, the direct use of solar energy can only achieve desirable operating results during periods of sufficient sunlight in the daytime, but cannot realize good operating results in case of low sunlight intensity or in the nighttime, which restricts the practical application of the solar energy evaporation and concentration technology to some extent.

In recent years, a photothermal interface has become a novel technical operating mode capable of utilizing the solar energy more efficiently. It can fully absorb and convert the sunlight radiated onto its surface into thermal energy, and concentrate the thermal energy onto a gas-liquid evaporation interface to reduce excessive thermal energy loss caused by environmental diffusion, such that a solar energy utilization rate is improved. In addition, with the advancement of photovoltaic industry technology and the development of energy storage facilities, intermittent photovoltaic power generation and storage become possible, and many energy conversion processes driven by clean photovoltaic electricity become possible accordingly. Electric-induced Joule heating effect utilizes the thermal energy generated by vibrations of electrons when the electric current passes through conductive materials, and calorific value converted thereby can act on the gas-liquid evaporation interface to effectively drive the evaporation of the aqueous phase. Moreover, it embraces considerable potential as a complement to the solar energy evaporation and concentration technology, and to supply energy in case of poor sunlight and in the nighttime, and the evaporation of the aqueous phase throughout a day can be achieved accordingly. However, in order to guarantee the water supply at the gas-liquid evaporation interface, the current photothermal-electric-induced Joule heating interface technology generally hydrophilically modifies material surfaces, and concurrently needs to leverage capillary wick suction effect generated from a complex capillary structure of porous substrate materials, such as polymer sponge, aerogel or natural polymer porous material (such as wood) to suck and extract the aqueous phase to the gas-liquid evaporation interface. The technology has been applied in seawater desalination and other fields, but material design requirements of these systems lead to some problems: first, the porous substrate materials are usually incapable of effectively absorbing sunlight or having conductive properties, therefore, it is necessary to modify their surfaces by using functional materials such as nanocarbon materials, which could easily result in uneven modification or unstable binding between modified components and the porous substrate materials. Although binding stability can be improved by other mechanical treatment methods, damage to the internal porous structure thereof can also be caused, weakening the capillary wick suction effect of the material system and even resulting to inability to effectively suck the aqueous phase; second, the porous substrate materials per unit often occupy a large space and have a large stacking volume, making them difficult to be transported and stored in an efficient manner; and third, the surface modification design of hydrophilic materials results in direct contact of a system of the photothermal-electric-induced Joule heating interface technology based on the porous substrate materials with the aqueous phase to be treated, therefore, it can only treat aqueous phase systems with light pollution loads such as seawater and low-salinity wastewater. Moreover, its structure and thermal energy conversion process are relatively unstable, making it insufficient to support the treatment of the aqueous phase systems with more complicated, corrosive and hazardous toxic components (such as the membrane concentrate of landfill leachate), or its service life will be greatly shortened in the aqueous phase systems, these restrictive factors impose many limitations on the potential application scenarios of the photothermal-electric-induced Joule heating interface technology.

Therefore, there is an urgent need to work out a technical solution to overcome the deficiencies in the prior art.

### SUMMARY

Based on the above reasons and in view of some problems in the reduction disposal of membrane concentrate in existing evaporation processes, the present disclosure aims to develop a multi-effect heat energy conversion system based on photothermal conversion of solar energy and electric-induced Joule heating effect, so as to realize the process of the reduction disposal through evaporation of landfill leachate membrane concentrate driven by green sustainable solar energy, and to provide a more reasonable, feasible, cost-effective and efficient technical route for the current reduction disposal through evaporation of the membrane concentrate.

Specifically, in the present disclosure, a hydrophobic polyvinylidene fluoride (PVDF) membrane is adopted as a substrate supporting material, microporous structure of the hydrophobic membrane is taken as an overflow path for generated hot steam, carbon nanotubes with surface carboxylated are dispersed to prepare a homogeneous suspension, the homogeneous suspension is sprayed on surfaces of the hydrophobic PVDF membrane and then dried and solidified, and carboxylated carbon nanotubes are then tightly bound with hydrophobic PVDF membrane substrate the through thermo-mechanical pressure treatment. Leachate membrane concentrate on a gas-liquid evaporation interface of the hydrophobic PVDF membrane substrate is efficiently heated and evaporated through photothermal effect and electric-induced Joule heating effect of the carboxylated carbon nanotubes, an aqueous phase thereof is driven to be separated, and a day-night switching mechanism driven by photothermal-electric-induced Joule heating effect is adopted to realize all-weather operation of the system, such that reduction disposal through evaporation of the leachate membrane concentrate can be realized in an efficient and reasonable manner.

An objective of the present disclosure is to provide a preparation method of a hydrophobically modified membrane based on multi-effect thermal energy conversion, and the method includes the following steps:
S1. dispersing carbon nanotubes with surfaces carboxylated in a solvent to form a dispersion;
S2. applying the dispersion evenly on a PVDF membrane, and drying to form a ready-to-use membrane;
S3. performing thermo-mechanical pressure treatment of the ready-to-use membrane to form a functional membrane with strong robustness; and
S4. placing the functional membrane with strong robustness in an alkane solution of PDMS containing a silane coupling agent, and then taking it out for drying.

In the present disclosure, a hydrophobic layer formed through reaction of PDMS with the silane coupling agent is different from other hydrophobic layers, and it has a transparent structure and has the property of absorbing and reserving sunlight to the greatest extent, and performing photothermal conversion in an efficient way; further, it has a compact and regular structure, contributing to excellent waterproof performance.

Further, the thermo-mechanical pressure treatment can guarantee stable binding between the carbon nanotubes and the microporous PVDF membrane substrate, and hydrophobic modification of the carboxylated carbon nanotubes can improve the stability of hydrophobically modified carboxylated carbon nanotubes on a gas-liquid mixed interface described in the present disclosure in spite of being impacted by gas-liquid fluid.

It is worth mentioning that a stable carboxylated carbon nanotube coating layer formed on surfaces of the microporous PVDF membrane can form a conductive network. Through the above hydrophobic modification method, the carboxylated carbon nanotubes can form a stable load on the surfaces of the microporous PVDF membrane, and the membrane loaded with the carboxylated carbon nanotubes are then hydrophobically modified, such that the internal conductivity of the coated carbon nanotube layer can be retained, and the carbon nanotubes are thus given a property of electric-induced Joule heating.

Further, conditions of the thermo-mechanical pressure treatment are as follows: a pressure of 8-12 Mpa, a temperature of 150-160° C. and a period of time of 2-3 h.

Further, alkane is selected from one or more of n-hexane, n-heptane, n-octane and n-butane.

Further, the PDMS is 2-10 wt % of the alkane solution.

Further, micropores in the PVDF membrane have a pore diameter of 0.22-0.35 μm on average.

Another objective of the present disclosure is to provide a composite membrane module device assembled by the hydrophobically modified membrane based on multi-effect thermal energy conversion that is prepared by the preparation method of a hydrophobically modified membrane based on multi-effect thermal energy conversion includes the hydrophobically modified membrane based on multi-effect thermal energy conversion and two titanium foils, and the two titanium foils are respectively connected to two ends of the hydrophobically modified membrane based on multi-effect thermal energy conversion.

Further, connecting positions between the hydrophobically modified membrane based on multi-effect thermal energy conversion and the titanium foils are not hydrophobically modified.

Another objective of the present disclosure is to provide an application of the composite membrane module device in reduction disposal of landfill leachate membrane concentrate.

The present disclosure has the following beneficial effects:
1. The technical route in the present disclosure only needs to be directly or indirectly driven by solar energy, so that concentration of the gas-liquid evaporation interface can be realized, which can efficiently and quickly evaporate and separate the aqueous phase in the leachate membrane concentrate, featuring extremely low energy consumption for operation, very little primary fossil energy consumption, high system energy conversion utilization rate and excellent process sustainability.
2. The technical route in the present disclosure can utilize the photothermal effect of solar energy and the electric-induced Joule heating effect driven by photovoltaic electricity to constantly supply thermal energy to the membrane module system. In order to address the intermittent and unstable problem of the utilization of solar energy, the present disclosure realizes flexible switching in the operating process due to the energy supply through driving force, thereby providing a more reasonable all-weather evaporation reduction operation strategy of the membrane concentrate.
3. The technical route in the present disclosure improves the stability of the operation process of the membrane module by performing hydrophobic modification on the membrane modules, and avoids serious electrochemical corrosion caused by contact between conductive material and salty aqueous phase in the traditional electric-induced Joule heating process, thereby guaranteeing good and stable operation performance of the membrane module system.
4. The technical route in the present disclosure realizes efficient reduction disposal through evaporation of the refractory membrane concentrate driven by the green sustainable solar energy, and ensures that the membrane module system has stable structure and performance in high toxic, salty and corrosive waste water environment, thereby providing a reasonable and feasible technical approach for the efficient reduction disposal through evaporation of the leachate membrane concentrate.

### BRIEF DESCRIPTION OF THE DRAWINGS

FIG. 1A illustrates changes in temperatures on surfaces of a membrane module driven by the photothermal effect of solar energy in Blank Example, Comparative Examples 1-3 and Example 1, respectively.

FIG. 1B illustrates changes in an evaporation rate of membrane concentrate driven by the photothermal effect of solar energy in Blank Example, Comparative Examples 1-3 and Example 1, respectively.

FIG. 2 illustrates a light energy conversion utilization rate driven by the photothermal effect of solar energy in Blank Example, Comparative Examples 1-3 and Example 1, respectively.

FIG. 3A illustrates changes in temperatures on surfaces of a membrane module driven by the electric-induced Joule heating effect in Comparative Examples 1-3 and Example 1, respectively.

FIG. 3B illustrates changes in an evaporation rate of membrane concentrate driven by the electric-induced Joule heating effect in Comparative Examples 1-3 and Example 1, respectively.

FIG. 4 illustrates electrical energy conversion utilization rates driven by the electric-induced Joule heating effect in Comparative Examples 1-3 and Example 1, respectively.

FIG. 5A illustrates changes in temperatures on surfaces of membrane module collaboratively driven by the photothermal effect of solar energy and the photovoltaic electric-induced Joule heating effect during a test period in Example 1.

FIG. 5B illustrates changes in an evaporation rate of membrane concentrate collaboratively driven by the photothermal effect of solar energy and the photovoltaic electric-induced Joule heating effect during a test period in Example 1.

FIG. 5C illustrates changes in temperatures on surfaces of membrane module collaboratively driven by the photothermal effect of solar energy and the photovoltaic electric-induced Joule heating effect during a test period in Comparative Example 3.

FIG. 5D illustrates changes in an evaporation rate of membrane concentrate collaboratively driven by the photothermal effect of solar energy and the photovoltaic electric-induced Joule heating effect during a test period in Comparative Example 3.

FIG. 6A illustrates an energy conversion utilization rate of the entire process collaboratively driven by the photothermal effect of solar energy and the photovoltaic electric-induced Joule heating effect in Example 1.

FIG. 6B illustrates an energy conversion utilization rate of the entire process collaboratively driven by the photothermal effect of solar energy and the photovoltaic electric-induced Joule heating effect in Comparative Example 3.

FIG. 7 illustrates changes in resistance values before and after operation of reduction disposal through evaporation of membrane concentrate in Comparative Examples 1-3 and Example 1, respectively.

FIG. 8A illustrates a comparison of the falling of surface-modified carboxylated carbon nanotube components and surface contamination before and after operation of reduction disposal through evaporation of membrane concentrate, and driven by the electric-induced Joule heating effect in Comparative Example 3.

FIG. 8B illustrates a comparison of the falling of surface-modified carboxylated carbon nanotube components and surface contamination before and after operation of reduction disposal through evaporation of membrane concentrate, and driven by the electric-induced Joule heating effect in Comparative Example 2.

FIG. 8C illustrates a comparison of the falling of surface-modified carboxylated carbon nanotube components and surface contamination before and after operation of reduction disposal through evaporation of membrane concentrate, and driven by the electric-induced Joule heating effect in Comparative Example 1.

FIG. 8D illustrates a comparison of the falling of surface-modified carboxylated carbon nanotube components and surface contamination before and after operation of reduction disposal through evaporation of membrane concentrate, and driven by the electric-induced Joule heating effect in Example 1.

### DETAILED DESCRIPTIONS OF THE EMBODIMENTS

Materials and reagents disclosed in the embodiments of the present disclosed are conventional materials and reagents commercially available, unless otherwise specifically defined.

### Example 1

A preparation method of a hydrophobically modified membrane based on multi-effect thermal energy conversion, including the following steps:
S1. 0.1 g of carboxylated carbon nanotubes were weighed and added to 100 mL of absolute ethanol to obtain an ethanol dispersion, the ethanol dispersion was shaken well and further dispersed ultrasonically with a needle-type ultrasonic probe for 30 min at a frequency of 40 kHz, and the ethanol dispersion was placed in an ice bath at 0° C. (with the aim of reducing the volatilization of ethanol solvent and guaranteeing the uniform dispersion of carbon nanotubes) to prepare a homogeneous suspension of carboxylated carbon nanotubes;
S2. 100 mL of the homogeneous suspension of the carboxylated carbon nanotubes were added into a storage tank of an air compression spray gun, and the suspension was evenly sprayed onto surfaces of hydrophobic microporous PVDF membranes, where each of the PVDF hydrophobic microporous membrane was a circular membrane with a diameter of 50 mm, a thickness of 0.1 mm and a pore size of 0.22 μm on average, an operating pressure of the air compression spray gun was 0.1-0.15 bar, the homogenized suspension was sprayed at a flow rate of 280 mL/min around, a diameter of a nozzle of the air compression spray gun was 1.8 mm, about 30 mL of the homogenized suspension was evenly sprayed on a surface of each of the hydrophobic microporous PVDF membranes, and the sprayed PVDF hydrophobic membrane was moved into a 60° C. oven for drying after the ethanol solvent on the surfaces of the hydrophobic microporous PVDF membranes had been fully evaporated at room temperature;
S3. the prepared hydrophobically modified membrane based on multi-effect thermal energy conversion was processed by means of thermo-mechanical pressure, such that the PVDF hydrophobic membrane was closely bonded with surface-modified carboxylated carbon nanotubes to guarantee strong robustness of a functional membrane module where the thermo-mechanical pressure were performed at 8 Mpa at a temperature of 150° C. for 2 h, and the functional membrane assembly with strong robustness was then prepared; and
S4. one side of the functional membrane module sprayed with the carboxylated carbon nanotubes after being treated by means of the thermo-mechanical pressure was floated on a surface of 20 mL n-heptane solution of 2 wt % polydimethylsiloxane (PDMS) (PDMS:KH550=10:1 m/m) containing a silane coupling agent KH550, and the functional membrane module was kept to contact the surface for 10 s, so that the carboxylated carbon nanotubes on the membrane surface were fully hydrophobically modified, the hydrophobically modified membrane module was then taken out for natural drying to prepare the hydrophobically modified membrane based on multi-effect thermal energy conversion. Further, a certain area on both sides of one surface of the membrane modified with the carboxylated carbon nanotubes was preserved without being hydrophobically modified for subsequent connection and assembly of electrodes at both ends.

### Example 2

A preparation method of a hydrophobically modified membrane based on multi-effect thermal energy conversion, including the following steps:
S1. 0.1 g of carboxylated carbon nanotubes were weighed and added to 100 mL of absolute ethanol to obtain an ethanol dispersion, the ethanol dispersion was shaken well and further dispersed ultrasonically with a needle-type ultrasonic probe for 30 min at a burst frequency of 50 kHz, and the ethanol dispersion was placed in an ice bath at 0° C. (with the aim of reducing the volatilization of ethanol solvent and guaranteeing the uniform dispersion of carbon nanotubes) to prepare a homogeneous suspension of carboxylated carbon nanotubes;
S2. 100 mL of the homogeneous suspension of the carboxylated carbon nanotubes were added into a storage tank of an air compression spray gun, and the suspension was evenly sprayed onto surfaces of hydrophobic microporous PVDF membranes, where each of the PVDF hydrophobic microporous membrane was a circular membrane with a diameter of 50 mm, a thickness of 0.1 mm and a pore size of 0.28 μm on average, an operating pressure of the air compression spray gun was 0.1-0.15 bar, the homogenized suspension was sprayed at a flow rate of 300 mL/min around, a diameter of a nozzle of the air compression spray gun was 1.8 mm, about 35 mL of the homogenized suspension was evenly sprayed on a surface of each of the hydrophobic microporous PVDF membranes, and the sprayed PVDF hydrophobic membrane was moved into a 60° C. oven for drying after the ethanol solvent on the surfaces of the hydrophobic microporous PVDF membranes had been fully evaporated at room temperature;
S3. the prepared hydrophobically modified membrane based on multi-effect thermal energy conversion was processed by means of thermo-mechanical pressure, such that the PVDF hydrophobic membrane was closely bonded with surface-modified carboxylated carbon nanotubes to guarantee strong robustness of a functional membrane module where the thermo-mechanical pressure were performed at 10 Mpa at a temperature of 160° C. for 3 h, and the functional membrane assembly with strong robustness was then prepared; and
S4. one side of the functional membrane module sprayed with the carboxylated carbon nanotubes after being treated by means of the thermo-mechanical pressure was floated on a surface of 20 mL n-heptane solution of 5 wt % polydimethylsiloxane (PDMS) (PDMS:KH550=12:1 m/m) containing a silane coupling agent KH550, and the functional membrane module was kept to contact the surface for 20 s, so that the carboxylated carbon nanotubes on the membrane surface were fully hydrophobically modified, the hydrophobically modified membrane module was then taken out for natural drying to prepare the hydrophobically modified membrane based on multi-effect thermal energy conversion. Further, a certain area on both sides of one surface of the membrane modified with the carboxylated carbon nanotubes was preserved without being hydrophobically modified for subsequent connection and assembly of electrodes at both ends.

### Example 3

A preparation method of a hydrophobically modified membrane based on multi-effect thermal energy conversion, including the following steps:
S1. 0.1 g of carboxylated carbon nanotubes were weighed and added to 100 mL of absolute ethanol to obtain an ethanol dispersion, the ethanol dispersion was shaken well and further dispersed ultrasonically with a needle-type ultrasonic probe for 30 min at a burst frequency of 45 kHz, and the ethanol dispersion was placed in an ice bath at 0° C. (with the aim of reducing the volatilization of ethanol solvent and guaranteeing the uniform dispersion of carbon nanotubes) to prepare a homogeneous suspension of carboxylated carbon nanotubes;
S2. 100 mL of the homogeneous suspension of the carboxylated carbon nanotubes were added into a storage tank of an air compression spray gun, and the suspension was evenly sprayed onto surfaces of hydrophobic microporous PVDF membranes, where each of the PVDF hydrophobic microporous membrane was a circular membrane with a diameter of 50 mm, a thickness of 0.1 mm and a pore size of 0.35 μm on average, an operating pressure of the air compression spray gun was 0.1-0.5 bar, the homogenized suspension was sprayed at a flow rate of 300 mL/min around, a diameter of a nozzle of the air compression spray gun was 1.8 mm, about 40 mL of the homogenized suspension was evenly sprayed on a surface of each of the hydrophobic microporous PVDF membranes, and the sprayed PVDF hydrophobic membrane was moved into a 60° C. oven for drying after the ethanol solvent on the surfaces of the hydrophobic microporous PVDF membranes had been fully evaporated at room temperature;
S3. the prepared hydrophobically modified membrane based on multi-effect thermal energy conversion was processed by means of thermo-mechanical pressure, such that the PVDF hydrophobic membrane was closely bonded with surface-modified carboxylated carbon nanotubes to guarantee strong robustness of a functional membrane module where the thermo-mechanical pressure were performed at 12 Mpa at a temperature of 155° C. for 3 h, and the functional membrane assembly with strong robustness was then prepared; and
S4. one side of the functional membrane module sprayed with the carboxylated carbon nanotubes after being treated by means of the thermo-mechanical pressure was floated on a surface of 20 mL n-heptane solution of 10 wt % polydimethylsiloxane (PDMS) (PDMS: KH550=8:1 m/m) containing a silane coupling agent KH550, and the functional membrane module was kept to contact the surface for 30 s, so that the carboxylated carbon nanotubes on the membrane surface were fully hydrophobically modified, the hydrophobically modified membrane module was then taken out for natural drying to prepare the hydrophobically modified membrane based on multi-effect thermal energy conversion. Further, a certain area on both sides of one surface of the membrane modified with the carboxylated carbon nanotubes was preserved without being hydrophobically modified for subsequent connection and assembly of electrodes at both ends.

### Comparative Example 1

The difference in the membrane module between Comparison Example 1 and Example 1 was only that: the membrane module in Comparison Example 1 was prepared by spraying the carboxylated carbon nanotubes on a hydrophobic microporous PVDF membrane substrate and was then subjected to the thermo-mechanical pressure for improving the robustness of binding, but the carboxylated carbon nanotubes loaded on the microporous membrane surface was not hydrophobically modified.

### Comparative Example 2

The difference in the membrane module between Comparison Example 2 and Example 1 was only that: the membrane module in Comparison Example 2 was prepared by spraying the carboxylated carbon nanotubes on a hydrophobic microporous PVDF membrane substrate, without being subjected to the thermo-mechanical pressure, nor the carboxylated carbon nanotubes loaded on the microporous membrane surface was hydrophobically modified.

### Comparative Example 3

The difference in the membrane module between Comparison Example 3 and Example 1 was only that: the membrane module in Comparison Example 3 was made from typical long-chain silane hydrophobic modifiers such as octadecyltrichlorosilane to PDMS in equal volume ratio.

### Blank Example

Blank Example served as a control group without any assistance of membrane module, that is, membrane concentrate of a nanofiltration membrane process section was subjected to the evaporation reduction disposal directly driven by the multi-effect thermal energy conversion.

### Test Example

Each of the membrane modules in Example 1, Comparative Examples 1-3 and Blank Example was evaporated, with a building method as follows: a titanium foil with dimensions of 20 mm×20 mm×0.3 mm was adhered by a double-sided conductive copper tape to two ends of a hydrophobically modified membrane based on multi-effect thermal energy conversion modified with carboxylated carbon nanotubes, and an adhesion area was pressed at 12 Mpa at room temperature for 30 min, so as to ensure that a titanium foil electrode and components of the carboxylated carbon nanotubes formed good contact.

A composite membrane module device was placed in a semi-open evaporation pond, the evaporation tank was used to contain landfill leachate membrane concentrate of a nanofiltration membrane process section as reduction disposal through evaporation target.

An operating effect test of the membrane module driven by the photothermal effect of solar energy was performed under natural light intensity simulated in a laboratory, the test lasted for 3 h, an infrared thermal imager was used to record changes in temperatures on the surfaces of the membrane module, a precision electronic balance was used to record evaporation reduction mass changes of the leachate membrane concentrate, and evaporation reduction rate and solar energy utilization rate of the membrane concentrate were then calculated according to a given formula.

An operating effect test of the membrane module driven by the electric-induced Joule heating effect was performed under laboratory simulation conditions, a variable-frequency alternating current driven and converted by small photovoltaic panels was used as driving energy, the membrane module was placed in completely light-proof conditions to eliminate interference from the photothermal conversion effect, an alternating current output power range was set to be 1.0 W, an alternating current frequency range was set to be 150-200 Hz, the test lasted for 3 h, the infrared thermal imager was used to record changes in temperatures on the surfaces of the membrane module, the precision electronic balance was used to record evaporation reduction mass changes of the leachate membrane concentrate, and evaporation reduction rate and electric energy utilization rate of the membrane concentrate were then calculated according to a given formula.

An operating effect test of the membrane module collaboratively driven by the photothermal-electric-induced Joule heating effect was performed under the laboratory simulation conditions. During its operation in the first 3 h, the membrane module was powered by only one simulation light with the natural light intensity, and the infrared thermal imager was used to record changes in temperatures on the surfaces of the membrane module; during its operation in the subsequent 3 h, the membrane module was powered only by variable-frequency alternating current, the infrared thermal imager was used to record changes in temperatures on the surfaces of the membrane module, the precision electronic balance was used to record evaporation reduction mass changes of the leachate membrane concentrate for 6 consecutive hours, and evaporation reduction rate, light energy utilization rate, electric energy utilization rate and comprehensive energy utilization rate were then calculated according to a given formula.

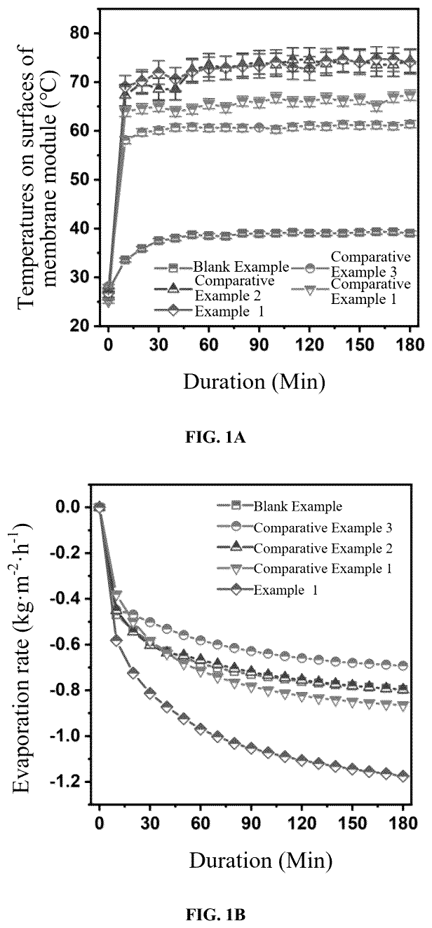

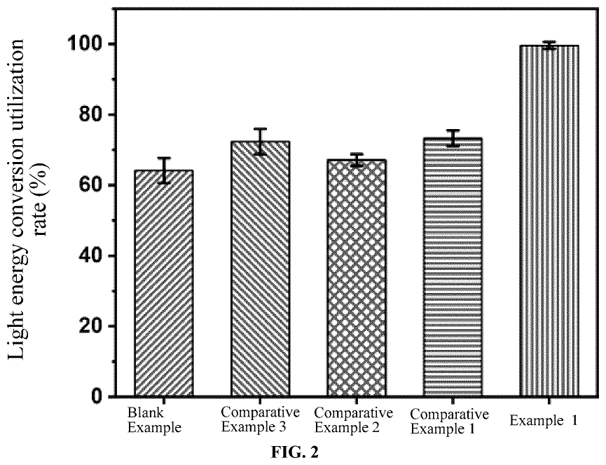

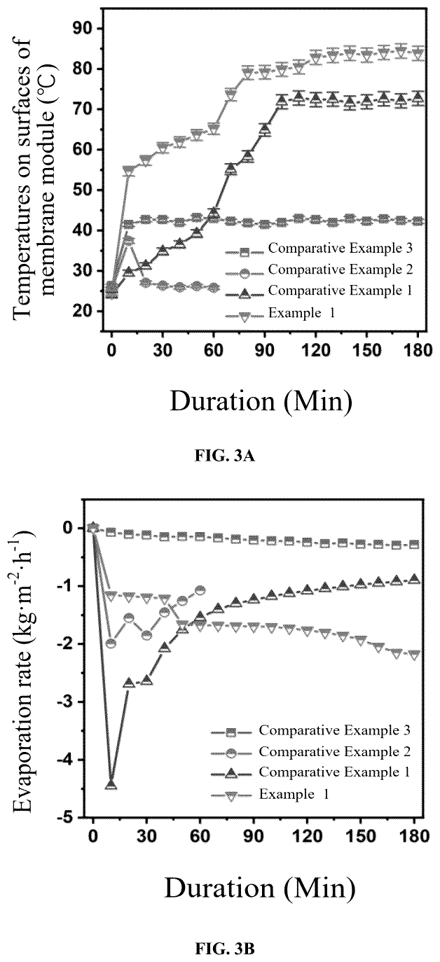

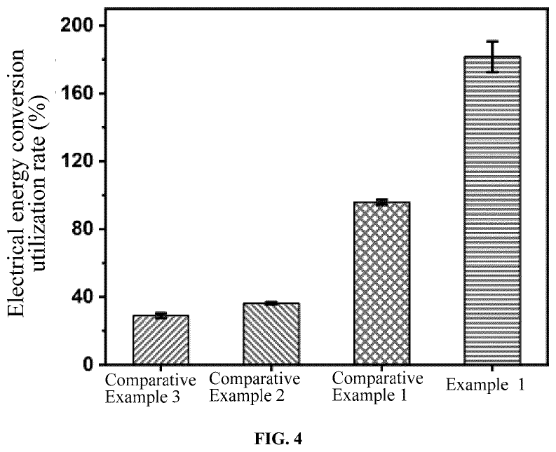

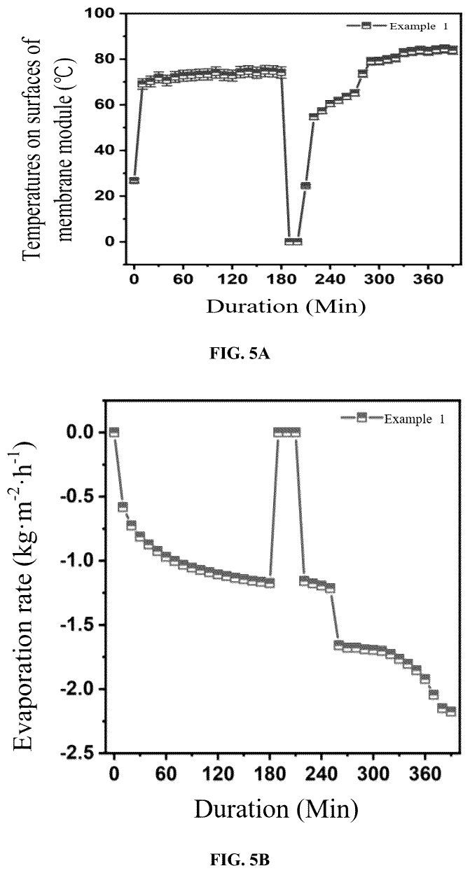

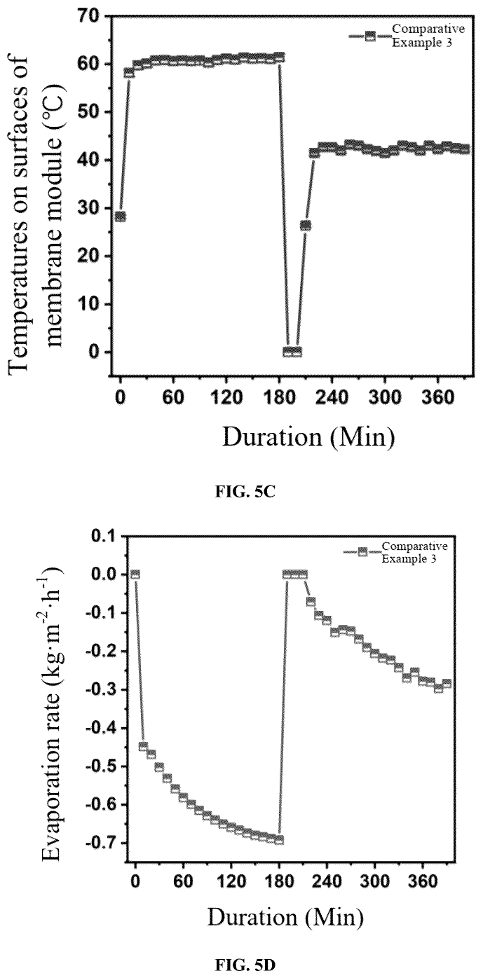

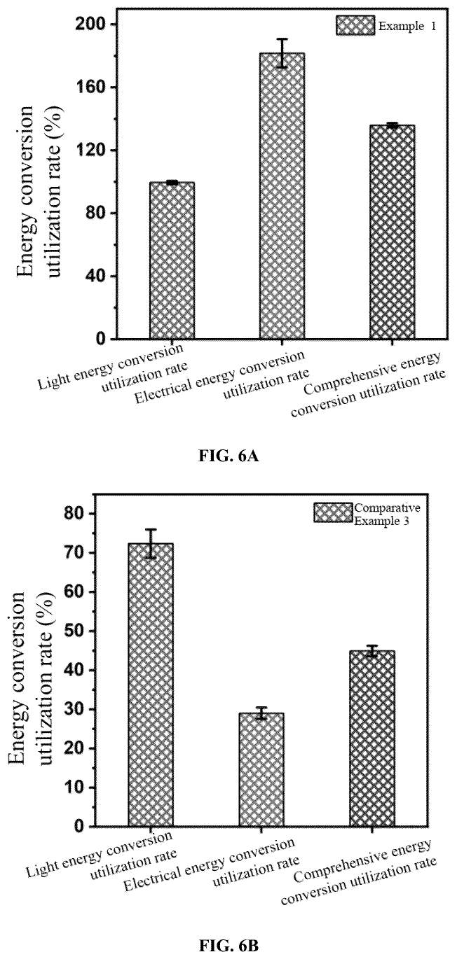

In order to test the membrane modules in Example 1, Comparative Examples 1-3 and Blank Example driven by the solar energy and the electric-induced Joule heating, and collaboratively driven by the solar energy and the electric-induced Joule heating, comparison was conducted among the series of data as follows. Comparison results were shown in Tables 1-2 and FIGS. 1-6.

Rate refers to a mass of landfill leachate of membrane concentrate that can be evaporated through the heating interface of the membrane module per unit area in unit time driven by the photothermal conversion of solar energy and the electric-induced Joule heating effect, and collaboratively driven by the photothermal-electric-induced Joule heating effect.

Efficiency, with regards to the membrane module driven by the photothermal conversion of solar energy, refers to a ratio of a sum of sensible heat enthalpy and latent heat enthalpy used for heating up and vaporizing for evaporation of the landfill leachate membrane concentrate to light energy irradiated and inputted to the surfaces of the membrane module during a test period; similarly, energy efficiency, with regard to the membrane module driven by electric-induced Joule heating effect, refers to a ratio of a sum of sensible heat enthalpy and latent heat enthalpy to electric energy irradiated and inputted to the surfaces of the membrane module during the test period; and energy efficiency, with regard to the membrane module collaboratively driven by the photothermal-electric-induced Joule heating effect, refers to a ratio of a sum of sensible heat enthalpy and latent heat enthalpy to a sum of light energy and electric energy irradiated and inputted to the surfaces of the membrane module during the test period.

Temperature refers to changes in temperatures on the surfaces of the membrane modules, driven by the photothermal conversion of solar energy and the electric-induced Joule heating effect, and collaboratively driven by the photothermal-electric-induced Joule heating effect, that are detected and recorded by the infrared thermal imager in real time, in which case, a lens of the infrared thermal imager should be kept parallel to the surfaces of the membrane modules, so that temperatures of the surfaces of the membrane modules can be recorded more accurately, the same below.

TABLE 1
Various Data of Membrane Modules Driven by Photothermal Effect of Solar
Energy in Example 1, Comparative Examples 1-3 and Blank Example

| Duration | Blank Example | | Comparative Example 3 | | Comparative Example 2 | | Comparative Example 1 | | Example 1 | |
|---|---|---|---|---|---|---|---|---|---|---|
| (min) | Temperature | Rate | Temperature | Rate | Temperature | Rate | Temperature | Rate | Temperature | Rate |
| 0 | 27.3 | 0.00 | 28.21 | 0.00 | 26.2 | 0.00 | 25.1 | 0.00 | 26.8 | 0.00 |
| 10 | 33.5 | −0.47 | 58.11 | −0.45 | 67.3 | −0.45 | 64.0 | −0.38 | 69.1 | −0.58 |
| 20 | 35.9 | −0.54 | 59.70 | −0.47 | 69.8 | −0.54 | 64.6 | −0.50 | 70.2 | −0.72 |
| 30 | 37.5 | −0.59 | 60.10 | −0.50 | 68.6 | −0.60 | 65.0 | −0.58 | 71.9 | −0.81 |
| 40 | 38.0 | −0.63 | 60.70 | −0.53 | 68.6 | −0.64 | 64.0 | −0.64 | 70.6 | −0.87 |
| 50 | 38.7 | −0.66 | 60.80 | −0.56 | 72.5 | −0.65 | 64.5 | −0.68 | 72.2 | −0.92 |
| 60 | 38.5 | −0.68 | 60.60 | −0.58 | 73.4 | −0.67 | 65.6 | −0.71 | 72.7 | −0.97 |
| 70 | 38.4 | −0.70 | 60.70 | −0.60 | 72.9 | −0.69 | 64.8 | −0.74 | 72.9 | −1.00 |
| 80 | 39.0 | −0.72 | 60.60 | −0.61 | 73.5 | −0.70 | 66.1 | −0.77 | 73.2 | −1.03 |
| 90 | 38.9 | −0.73 | 60.70 | −0.63 | 74.1 | −0.72 | 65.8 | −0.78 | 73.3 | −1.05 |
| 100 | 39.0 | −0.74 | 60.30 | −0.64 | 73.5 | −0.73 | 66.8 | −0.80 | 74.1 | −1.07 |
| 110 | 39.2 | −0.75 | 60.80 | −0.65 | 74.6 | −0.75 | 66.0 | −0.81 | 73.0 | −1.09 |
| 120 | 39.0 | −0.76 | 61.10 | −0.66 | 74.6 | −0.76 | 66.0 | −0.82 | 72.8 | −1.11 |
| 130 | 39.0 | −0.77 | 60.90 | −0.67 | 73.7 | −0.76 | 66.7 | −0.83 | 74.3 | −1.12 |
| 140 | 39.0 | −0.78 | 61.30 | −0.67 | 74.4 | −0.77 | 66.1 | −0.84 | 74.6 | −1.13 |
| 150 | 39.2 | −0.78 | 61.10 | −0.68 | 74.4 | −0.78 | 66.5 | −0.85 | 74.0 | −1.14 |
| 160 | 39.3 | −0.79 | 61.20 | −0.68 | 73.5 | −0.79 | 65.1 | −0.86 | 74.7 | −1.16 |
| 170 | 39.3 | −0.79 | 61.00 | −0.69 | 73.5 | −0.79 | 66.9 | −0.86 | 74.6 | −1.16 |
| 180 | 39.0 | −0.80 | 61.39 | −0.69 | 74.4 | −0.80 | 67.3 | −0.86 | 74.1 | −1.18 |

| | | | | | | | | | |
|---|---|---|---|---|---|---|---|---|---|
| Efficiency | 64.12 | — | 72.35 | — | 67.14 | — | 73.29 | — | 9.59 |

TABLE 2
Various Data of Membrane Modules Driven by Electric-induced Joule
Heating Effect in Example 1 and Comparative Examples 1-3

| Duration | Comparative Example 3 | | Comparative Example 2 | | Comparative Example 1 | | Example 1 | |
|---|---|---|---|---|---|---|---|---|
| (min) | Temperature | Rate | Temperature | Rate | Temperature | Rate | Temperature | Rate |
| 0 | 26.35 | 0.00 | 25.3 | 0.00 | 24.0 | 0.00 | 24.5 | 0.00 |
| 10 | 41.45 | −0.07 | 37.4 | −1.99 | 29.5 | −4.45 | 54.7 | −1.16 |
| 20 | 42.66 | −0.11 | 27.0 | −1.55 | 31.2 | −2.69 | 57.3 | −1.18 |
| 30 | 42.66 | −0.12 | 26.3 | −1.85 | 34.8 | −2.64 | 60.5 | −1.19 |
| 40 | 41.95 | −0.15 | 25.9 | −1.45 | 36.5 | −2.08 | 61.9 | −1.21 |
| 50 | 43.17 | −0.14 | 26.2 | −1.25 | 39.2 | −1.76 | 63.6 | −1.66 |
| 60 | 42.97 | −0.15 | 25.8 | −1.07 | 44.2 | −1.54 | 65.2 | −1.68 |
| 70 | 42.26 | −0.17 | — | — | 55.1 | −1.40 | 73.6 | −1.68 |
| 80 | 41.85 | −0.19 | — | — | 58.3 | −1.30 | 79.1 | −1.69 |
| 90 | 41.45 | −0.21 | — | — | 64.9 | −1.24 | 79.2 | −1.69 |
| 100 | 41.95 | −0.22 | — | — | 71.9 | −1.17 | 79.9 | −1.70 |
| 110 | 42.97 | −0.22 | — | — | 72.8 | −1.13 | 80.5 | −1.73 |
| 120 | 42.66 | −0.24 | — | — | 72.4 | −1.08 | 82.8 | −1.76 |
| 130 | 41.95 | −0.27 | — | — | 72.5 | −1.04 | 83.3 | −1.80 |
| 140 | 42.97 | −0.25 | — | — | 71.6 | −1.01 | 83.8 | −1.85 |
| 150 | 42.26 | −0.28 | — | — | 71.9 | −0.98 | 83.4 | −1.92 |
| 160 | 42.86 | −0.28 | — | — | 72.6 | −0.95 | 84.0 | −2.04 |
| 170 | 42.46 | −0.30 | — | — | 72.1 | −0.92 | 84.5 | −2.15 |
| 180 | 42.26 | −0.28 | — | — | 72.7 | −0.90 | 83.8 | −2.18 |

| | | | | | | | |
|---|---|---|---|---|---|---|---|
| Efficiency | 29.02 | — | 36.31 | — | 95.84 | — | 181.64 |

TABLE 3
Various Data of Membrane Modules Collaboratively Driven by Photothermal Conversion of Solar Energy
and Photovoltaic Electric-induced Joule Heating Effect in Example 1, Comparative Examples 3

| | | | | | | Example 1 | | Comparative Example 3 | |
|---|---|---|---|---|---|---|---|---|---|
| | Example 1 | | Comparative example 3 | | | Driven by electric-induced | | Driven by electric-induced | |
| Duration | Driven by light energy | | Driven by light energy | | Duration | Joule heating effect | | Joule heating effect | |
| (min) | Temperature | Rate | Temperature | Rate | (min) | Temperature | Rate | Temperature | Rate |
| 0 | 26.77 | 0.00 | 28.21 | 0.00 | 180 | 24.48 | 0.00 | 26.35 | 0.00 |
| 10 | 69.05 | −0.58 | 58.11 | −0.45 | 190 | 54.67 | −1.16 | 41.45 | 0.07 |
| 20 | 70.19 | −0.72 | 59.70 | −0.47 | 200 | 57.32 | −1.18 | 42.66 | −0.11 |
| 30 | 71.95 | −0.81 | 60.10 | −0.50 | 210 | 60.49 | −1.19 | 42.66 | −0.12 |
| 40 | 70.60 | −0.87 | 60.70 | −0.53 | 220 | 61.91 | −1.21 | 41.95 | −0.15 |
| 50 | 72.15 | −0.92 | 60.80 | −0.56 | 230 | 63.65 | −1.66 | 43.17 | 0.14 |
| 60 | 72.67 | −0.97 | 60.60 | −0.58 | 240 | 65.18 | −1.68 | 42.97 | −0.15 |
| 70 | 72.88 | −1.00 | 60.70 | −0.60 | 250 | 73.64 | −1.68 | 42.26 | 0.17 |
| 80 | 73.19 | −1.03 | 60.60 | −0.61 | 260 | 79.05 | −1.69 | 41.85 | −0.19 |
| 90 | 73.29 | −1.05 | 0.70 | −0.63 | 270 | 79.15 | −1.69 | 41.45 | −0.21 |
| 100 | 74.12 | −1.07 | 60.30 | −0.64 | 280 | 79.87 | −1.70 | 41.95 | −0.22 |
| 110 | 72.98 | −1.09 | 60.80 | −0.65 | 290 | 80.48 | −1.73 | 42.97 | −0.22 |
| 120 | 72.77 | −1.11 | 61.10 | −0.66 | 300 | 82.82 | −1.76 | 42.66 | 0.24 |
| 130 | 74.33 | −1.12 | 60.90 | −0.67 | 310 | 83.33 | −1.80 | 41.95 | −0.27 |
| 140 | 74.64 | −1.13 | 61.30 | −0.67 | 320 | 83.84 | −1.85 | 42.97 | −0.25 |
| 150 | 74.02 | −1.14 | 61.10 | −0.68 | 330 | 83.44 | −1.92 | 42.26 | −0.28 |
| 160 | 74.74 | −1.16 | 61.20 | −0.68 | 340 | 84.05 | −2.04 | 42.86 | −0.28 |
| 170 | 74.64 | −1.16 | 61.00 | −0.69 | 350 | 84.46 | −2.15 | 42.46 | −0.30 |
| 180 | 74.12 | −1.18 | 61.39 | −0.69 | 360 | 83.84 | −2.18 | 42.26 | −0.28 |

| | | | | | |
|---|---|---|---|---|---|
| Photothermal | 99.60 | 72.35 | Electrothermal | 181.64 | 29.02 |
| efficiency | | | efficiency | | |

| | |
|---|---|
| Comprehensive energy conversion | 135.96 |
| utilization rate of Example 1 | |
| Comprehensive energy conversion | 44.93 |
| utilization rate of Comparative Example 3 | |

Efforts were also made to explore the changes in resistance values before and after operation of the reduction disposal through evaporation of the membrane concentrate in Example 1 and Comparative Examples 1-3, with a test method as follows: a universal meter was connected to two sides of a membrane module with titanium foil electrodes packaged at both ends, changes in the resistance values of membrane modules prepared under different modification conditions were detected before and after operation of the reduction disposal through evaporation of the membrane concentrate driven by the electric-induced Joule heating effect, such that the stability of surface modification components of the membrane module before and after the operation can be revealed, and property changes of a conductive network formed by surface modification components of the membrane module before and after the operation can be detected. Results were shown in Table 4 and FIG. 7.

TABLE 4
Changes in Resistance Values Before and After Operation
of Reduction Disposal through Evaporation of Membrane
Concentrate in Example 1 and Comparative Examples

| | Resistance value | Resistance value |
|---|---|---|
| Sample | before operation (Ω) | after operation (Ω) |
| Example 1 | 1196.7 | 1520.7 |
| Comparative Example 1 | 1326.7 | 4019.3 |
| Comparative Example 2 | 1456.7 | 7784.0 |
| Comparative Example 3 | 2649.0 | 4577.3 |

As can be seen from Table 4, an increase in the resistance value of the membrane module before and after the operation of reduction disposal through evaporation of the membrane concentrate driven by the electric-induced Joule heating effect in Example 1 is the smallest compared with those in Comparative Examples 1-3, which illustrates that the hydrophobic modification and thermo-mechanical pressure treatment of the surfaces of the membrane module adopted in Example 1 have an obvious effect on improving the robustness of the membrane module against electrochemical erosion; in Comparative Example 1, the binding between the carboxylated carbon nanotubes and the hydrophobic microporous PVDF membrane substrate is improved through the thermo-mechanical pressure treatment, but no hydrophobic modification is performed, and the carboxylated carbon nanotubes are in direct contact with the high-salinity membrane concentrate instead, which weakens the network conductivity caused by electrochemical corrosion in the process of electric-induced Joule heating effect, and accordingly drives the resistance value up; in Comparative Example 2, neither thermo-mechanical pressure treatment nor hydrophobic modification is performed for the membrane module, which not only makes the carboxylated carbon nanotubes on the surfaces of the membrane module subjected to electrochemical corrosion, but also results in loose binding between the carboxylated carbon nanotubes and the hydrophobic microporous PVDF membrane substrate, and serious falling of the carbon nanotube components, and the conductive network is seriously damaged, and the resistance value of the membrane module after operation shows the most obvious increase; in Comparative Example 3, a non-transparent hydrophobic modification layer itself interferes with the conductive network of carboxylated carbon nanotubes, resulting in a higher initial resistance value of the membrane module, and the corresponding heat accumulation damage effect further drives the resistance value of the membrane module after operation in Comparative Example 3 to some extent; and the above comparison demonstrates the effectiveness and stability of the membrane module in Example 1 in ensuring resistance to electrochemical corrosion.

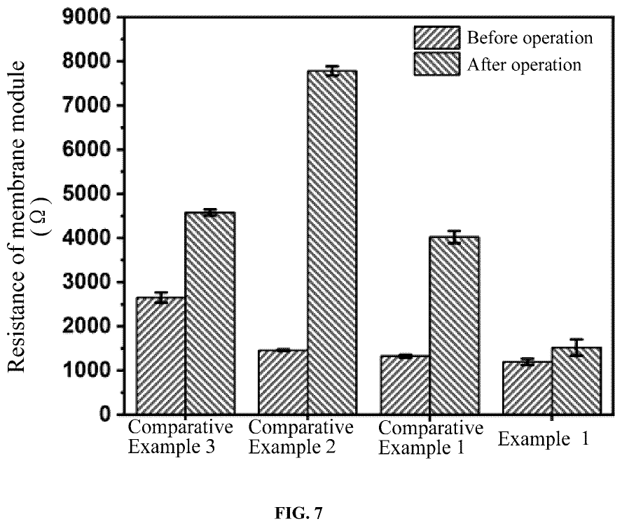

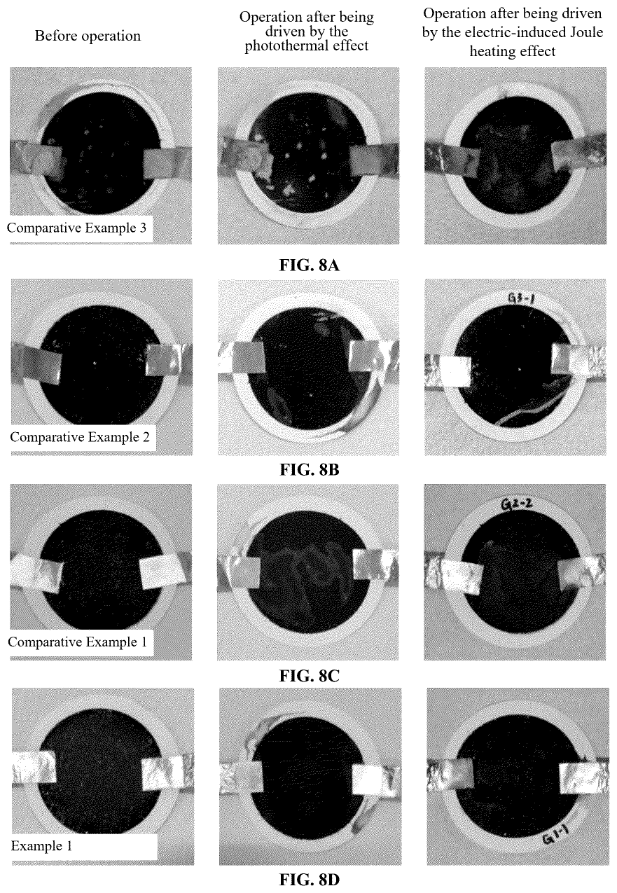

FIGS. 8A, 8B, 8C and 8D illustrate a comparison of the falling of the surface-modified carboxylated carbon nanotube components and surface contamination of the membrane module before and after the operation of reduction disposal through evaporation of the membrane concentrate in Comparative Examples 3-1 and Example 1, respectively. Comparison results indicate that the membrane module in Example 1 has a better stability than those in Comparative Examples 1-3, because the membrane module 1 in Comparative Example 1 is only subjected to the thermo-mechanical pressure treatment, without hydrophobic modification, which makes the carboxylated carbon nanotubes on the surfaces of the membrane module contaminated by hot steam generated from the membrane concentrate, thereby resulting in a reduction in efficient evaporation area and weakening the evaporation reduction performance of the membrane concentrate; neither thermo-mechanical pressure treatment nor hydrophobic modification is performed for the membrane module in Comparative Example 2, so that the membrane module is incapable of resisting the contamination arising from hot steam impact of the membrane concentrate, and is incapable of ensuring good binding between the carboxylated carbon nanotubes and the hydrophobic microporous PVDF membrane substrate, thereby resulting in serious falling of the carboxylated carbon nanotube components and the greatly weakening the evaporation reduction performance after operation; and it seems that the membrane module in Comparative Example 3 has no considerable change before and after the operation of reduction disposal through evaporation, actually, because the non-transparent hydrophobic modification layer on the surfaces of the membrane module seriously affects the photothermal conversion of solar energy and the electric-induced Joule heating conversion performance thereof.

For those skilled in the art, it is apparent that the present disclosure is not limited to the details of the above exemplary embodiments, and the present disclosure may be implemented in other specific forms without departing from the spirit or basic features of the present disclosure. Therefore, the embodiments should be regarded as illustrative and non-restrictive no matter from which point of view. The scope of the present disclosure is defined by the appended claims rather than the above specification, and therefore, it is intended that all changes which fall within the meaning and scope of equivalency of the claims are embraced in the present disclosure.

In addition, it should be understood that although the specification is described according to implementations, each implementation does not include only one independent technical solution, the description is for clarity only, and those skilled in the art should take the description as a whole, the technical solutions in the various embodiments may be appropriately combined to form other implementations understandable by those skilled in the art.

1. A preparation method of a hydrophobically modified membrane based on multi-effect thermal energy conversion, comprising the following steps:
S1. dispersing carbon nanotubes with surfaces carboxylated in a solvent to form a dispersion;
S2. applying the dispersion evenly on a PVDF membrane, and drying to form a ready-to-use membrane;
S3. performing thermo-mechanical pressure treatment of the ready-to-use membrane to form a functional membrane with strong robustness; and
S4. placing the functional membrane with strong robustness in an alkane solution of PDMS containing a silane coupling agent, and then taking it out for drying.

2. The preparation method of a hydrophobically modified membrane based on multi-effect thermal energy conversion according to claim 1, wherein conditions of the thermo-mechanical pressure treatment are as follows: a pressure of 8-12 Mpa, a temperature of 150-160° C. and a period of time of 2-3 h.

3. The preparation method of a hydrophobically modified membrane based on multi-effect thermal energy conversion according to claim 1, wherein alkane is selected from one or more of n-hexane, n-heptane, n-octane and n-butane.

4. The preparation method of a hydrophobically modified membrane based on multi-effect thermal energy conversion according to claim 1, wherein the PDMS is 2-10 wt % of the alkane solution.

5. The preparation method of a hydrophobically modified membrane based on multi-effect thermal energy conversion according to claim 1, wherein micropores in the PVDF membrane have a pore diameter of 0.22-0.35 μm on average.

6. A composite membrane module device assembled by the hydrophobically modified membrane based on multi-effect thermal energy conversion that is prepared by the preparation method of a hydrophobically modified membrane based on multi-effect thermal energy conversion according to claim 1, wherein the composite membrane module device comprises the hydrophobically modified membrane based on multi-effect thermal energy conversion and two titanium foils, and the two titanium foils are respectively connected to two ends of the hydrophobically modified membrane based on multi-effect thermal energy conversion.

7. The composite membrane module device assembled by the hydrophobically modified membrane based on multi-effect thermal energy conversion that is prepared by the preparation method of a hydrophobically modified membrane based on multi-effect thermal energy conversion according to claim 6, wherein connecting positions between the hydrophobically modified membrane based on multi-effect thermal energy conversion and the titanium foils are not hydrophobically modified.

8. An application of the composite membrane module device according to claim 6 in reduction disposal through evaporation of landfill leachate membrane concentrate.
